(19) United States
(12) Patent Application Publication
(10) Pub. No.: US 2026/0219861 A1
(43) Pub. Date: Jul. 30, 2026

(54) GENERATING CUSTOM BUILDS FROM IMAGES OF SOFTWARE APPLICATIONS

(71) Applicant: Salesforce, Inc., San Francisco, CA (US)

(72) Inventors: Jason A. Schroeder, Remote, CA (US); Zhihong Xu, Bellevue, WA (US)

(21) Appl. No.: 19/038,396

(22) Filed: Jan. 27, 2025

(51) Int. Cl. G06F 8/61

(52) U.S. Cl. CPC G06F 8/63

(57) ABSTRACT

Methods and corresponding systems and apparatuses for building customized applications from a base application are described. For example, source code for a base application and one or more assets that are required by the base application may be obtained. A build cache generated by a build automation tool upon building the base application may be obtained. A containerized software image file for the base application may be generated based at least in part on the source code, the one or more assets, and the build cache. One or more customizations to be applied to the base application may be determined. A customized version of the base application may be generated based at least in part on the containerized software image file for the base application and the one or more customizations.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

The present disclosure relates generally to approaches for generating custom builds from images of software applications.

### BACKGROUND

Cloud Native Buildpacks (CNBs) may transform application source code into container images that can run on cloud platforms. CNBs automate the process of building container images by analyzing source code, determining necessary dependencies, and creating an OCI-compliant image without a Dockerfile. Buildpacks may perform auto-detection of application requirements, ensuring that the appropriate runtime environment and dependencies are included in the final image.

### BRIEF DESCRIPTION OF THE DRAWINGS

The included drawings are for illustrative purposes and serve only to provide examples of possible structures and process steps for the disclosed techniques. These drawings in no way limit any changes in form and detail that may be made to implementations by one skilled in the art without departing from the spirit and scope of the disclosure.

FIG. 1 shows a block diagram of an example computing environment, according to some embodiments.

FIG. 2 shows a flow diagram of an example process for generating an image of a base application, according to some embodiments.

FIG. 3 shows an example diagram for generating an image of a base application, according to some embodiments.

FIG. 4 shows a flow diagram of an example process for generating a custom mobile application using an image of a base application, according to some embodiments.

FIG. 5 shows an example diagram for generating a custom mobile application using an image of a base application, according to some embodiments.

FIG. 6 shows another example diagram for generating another custom mobile application using the image of the base application, according to some embodiments.

FIG. 7 shows a flow diagram of an example process, according to some embodiments.

FIG. 8 shows a block diagram illustrating an example computing system.

### DETAILED DESCRIPTION

Examples of systems and methods for building customized applications from an image of a base application are described herein with reference to certain implementations. As used herein, a base application may refer to a software application that provides a baseline level of functionality, which may be modified (or customized, or extended). These examples are being provided solely to add context and aid in the understanding of the present disclosure. It will thus be apparent to one skilled in the art that the techniques described herein may be practiced without some or all of these specific details. In other instances, well-known process operations have not been described in detail in order to avoid unnecessarily obscuring the present disclosure. Other applications are possible, such that the following examples should not be taken as definitive or limiting either in scope or setting.

The described subject matter may be implemented in the context of any computer-implemented system, such as a software-based system, a database system, a multi-tenant environment, or the like. Moreover, the described subject matter may be implemented in connection with two or more separate and distinct computer-implemented systems that cooperate and communicate with one another. One or more examples may be implemented in numerous ways, including as a process, an apparatus, a system, a device, a method, a computer-readable medium such as a non-transitory computer-readable storage medium containing computer-readable instructions or computer program code, or as a computer program product comprising a computer usable medium having a computer-readable program code embodied therein.

Software developers sometimes create base applications, which may provide core functionality from which other applications may be built. For example, a base application may provide file system operations, task running capabilities, plug-in system for various functionality, command-line interface support, configuration files, among other resources.

Embodiments described herein provide a claimed solution that is necessarily rooted in computer technology (e.g., computer networks). The claimed solution involves building custom applications from a base application, in conjunction with reusing a build cache generated when building the base application and any required assets. The build cache may be included in the software image to make these results available during the building of the custom application. This avoids having to repeat certain build steps. Further, any assets required by the base application, such as software libraries, may be included in the software image to make these assets available during the building of the custom application. This avoids having to repeat certain download steps. According to various embodiments, the resulting software image (e.g., a OCI image) can be executed to create containers for building custom applications. Each custom application will have its own container into which custom configurations or assets can be implemented and from which mobile applications may be generated. Advantageously, the approaches for building customized applications may be faster and require fewer computing resources as compared to the more traditional approach of

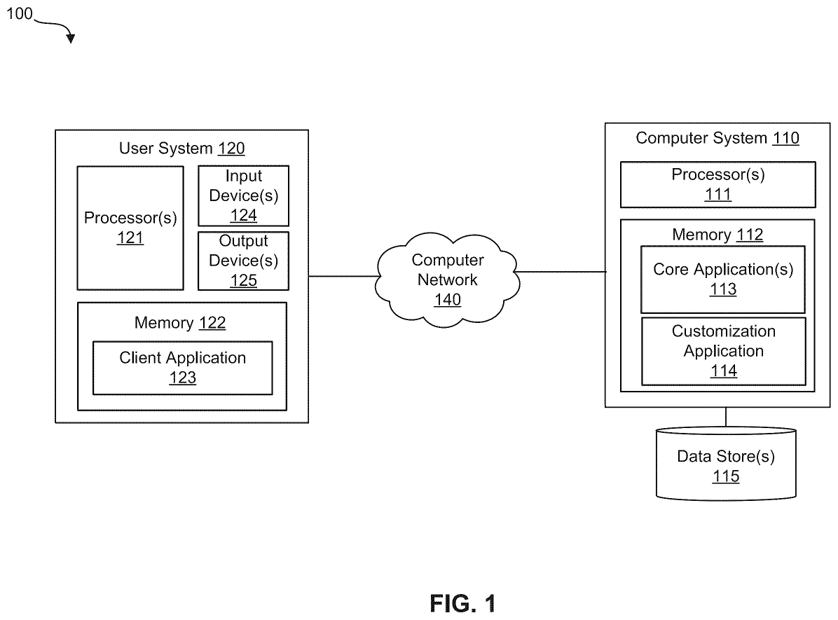

FIG. 1 shows a block diagram of an example computing environment 100 incorporating one or more implementations. The computing environment 100 includes a computer system 110 and a user system 120, which may communicate through one or more computer networks 140 (e.g., the Internet). The computer network(s) 140 may include one or more wireless networks, one or more wired networks, or a combination of wired and wireless networks. For example, the computer network 140 may be any one or any combination of one or more LANs (local area networks), WANs (wide area networks), virtual networks, and wireless networks, among others.

The user system 120 may include a client application 123 configured to interact with the computer system 110. The client application 123 may be a web browser or thin-client program configured to communicate with the computing system 110, for example, through one or more application programming interfaces (APIs). As an example, a web API may enable exchange of Hypertext Transfer Protocol (HTTP) requests and responses between the client application 123 and applications running on the computer system 110, such as one or more core applications 113 and/or a customization application 114. Alternatively, in some implementations, the core application(s) 113 and/or the customization application 114 may be installed and executed on the user system 120 as a standalone program. The user system 120 may include one or more processors 121 and memory 122. The processor(s) 121 may include general-purpose processors, special-purpose processors, or combinations thereof. The memory 122 may include one or more memory devices comprising non-volatile storage, volatile storage, or a combination thereof. Further, the user system 120 may include one or more input devices 124 (e.g., keyboard, touchscreen, etc.) and one or more output devices 125 (e.g., display screen(s), headset, etc.).

The computer system 110 may provide various cloud-based services, such as one or more core applications 113 and/or the customization application 114. The computer system 110 may include one or more processors 111 and memory 112. The processor(s) 111 may include general-purpose processors, special-purpose processors, or combinations thereof. The memory 112 may include one or more memory devices comprising non-volatile storage, volatile storage, or a combination thereof. The computer system 110 may be configured to provide access to one or more core applications 113 and/or the customization application 114, for example, upon execution by the processor(s) 111. In various embodiments, the computer system 110 may implement a Software as a Service (SaaS) model, a Platform as a Service (PaaS) model, or any other cloud computing model, to facilitate access to the core application(s) 113 and/or the customization application 114.

The core application(s) 113 may be provided to users associated with one or more tenants (e.g., enterprise organizations) of the computer system 110 and may provide functionality relating to sales, customer support, customer relationship management (CRM), marketing, finance, messaging, electronic commerce, data analytics, for example. Thus, the core application(s) 113 may form a software suite available to users of the computer system 110, for example, on a subscription basis. In some implementations, servers in different data centers may provide the core application(s) 113. In various embodiments, the customization application 114 may be configured to generate custom mobile applications using an image of a base application, as described herein.

The computer system 110 may be associated with one or more data stores 115, which may be accessible through wired or network-based connections. The data store(s) 115 may include tenant-specific data that can only be accessed by users associated with the same tenant. In a multi-tenant environment, the computer system 110 may isolate the data store(s) such that users associated with one tenant have no access or visibility into local data belonging to a different tenant. Further, within a single tenant, access permissions may be configured on a user-by-user basis, such that permission levels may vary among users, for example, based on position, title, role, etc. The data store(s) 115 may store various tenant-specific data, such as data relating to sales, customer support, customer relationship management (CRM), marketing, finance, messaging, electronic commerce, data analytics, and/or the like.

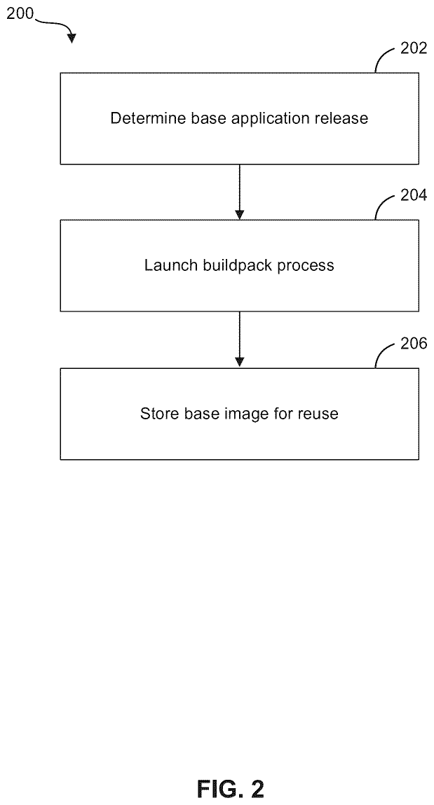

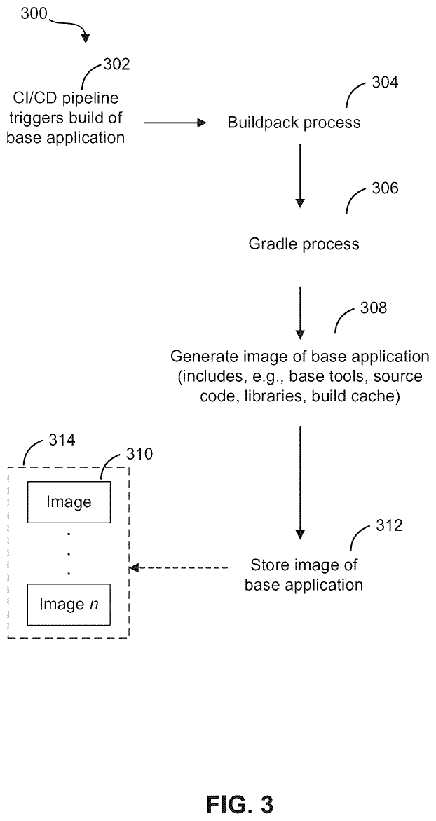

FIG. 2 shows a flow diagram of an example process for generating an image of a base application, according to some embodiments. The process 200 can be performed by one or more processors of a computer system, such as the computer system 110 of FIG. 1, for example, upon executing the customization application 114. The process 200 is described in reference to FIG. 3, which shows an example diagram 300 for generating the image of the base application, according to some embodiments.

At block 202, a release of a base application may be determined. For example, as shown in FIG. 3, a continuous integration (CI) and continuous delivery (CD) (or CI/CD) pipeline 302 may be configured to automatically trigger builds of the base application upon detecting changes (or merges) in a release branch. According to various embodiments, the base application may provide core functionality from which derivative (or customized) applications may be built. For example, the base application may provide file system operations, task running capabilities, plug-in(s) for various functionality, command-line interface support, and configuration files, among other resources. As an example, the base application may be an application that incorporates various functionality of the core applications 113. In this example, the base application may be used to build a custom application (e.g., mobile application) for a given entity, such as a customer of a CRM system (e.g., organization, company, etc.), that provides functionality similar to the base application but with modifications tailored to that entity, such as custom branding (e.g., content, color schemes, logos, graphics, etc.) and configurations (e.g., Uniform Resource Locators (URLs), etc.).

At block 204, after the build is triggered, a buildpack process 304 may be launched to generate the image of the base application. According to various embodiments, a Cloud Native Buildpack (CNB) process may be initiated, although other buildpack implementations are contemplated. The CNB process may automate the process of building a container image (e.g., OCI image) of the base application by analyzing corresponding source code, determining necessary dependencies, and generating an OCI-compliant image. When initiated, the CNB process may involve a setup stage and a build stage.

The setup stage may involve creating a build environment. The build environment may be created by cloning the release branch of the base application and ensuring all necessary files are included in the build environment, such as source code corresponding to the base application and dependencies (e.g., drivers, development kits, plug-ins, libraries, APIs, etc.).

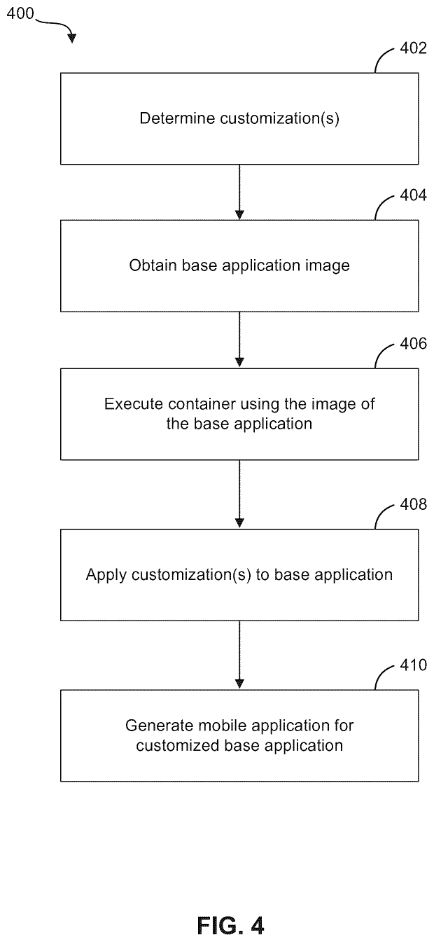

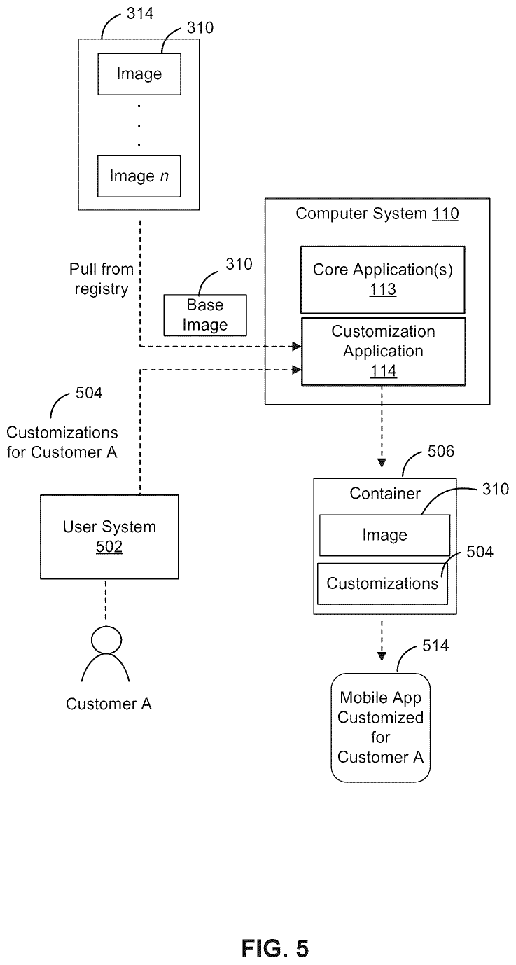

The setup stage may also specify a build automation tool that will be used to build the base application. According to various embodiments, the base application may be built using Gradle Build Tool (“Gradle”) (developed by Gradle, Inc., available at https://gradle.org/), although any build automation tool may be used. During this stage, the computer system may instruct Gradle to store all downloaded assets (e.g., drivers, development kits, plug-ins, libraries, APIs, etc.) in a directory in the image of the base application to be generated, for example, by defining an environment variable (e.g., GRADLE_USER_HOME) to reference a path corresponding to the directory. Later, when the image of the base application is used to build a customized application, as described in reference to FIGS. 4 and 5, Gradle may be instructed to obtain the downloaded assets from this directory, eliminating the need to re-download the assets and thus mitigating potential network-related delays or network dependencies to the build process.

The build stage may involve configuring build-time and runtime environments to facilitate the generation of the image of the base application. During the build phase, a Gradle process 306 may be initiated to compile the source code corresponding to the base application, resolve dependencies from repositories, and package the base application into a distributable format (e.g., a JAR file, WAR file, etc.). The Grade process 306 may also be configured to output a build cache. The build cache may store outputs resulting from building the base application, which may be reused to improve build performance for subsequent builds derived from the base application. After the Gradle process 306, the build process may generate an image 308 of the base application, which includes application artifacts (e.g., compiled code and packaged files) resulting from the Gradle process 306, including the downloaded assets and the build cache.

At block 206, the resulting image 310 may be stored. According to some embodiments, the image 310 may be pushed 312 to a registry 314. For example, the registry 314 may be an Open Container Initiative (OCI)-compliant registry designed to store, distribute, and manage container images and other artifacts in a way that ensures interoperability across different platforms and tools.

FIG. 4 shows a flow diagram of an example process for generating a custom mobile application using an image of a base application, according to some embodiments. The process 400 can be performed by one or more processors of a computer system, such as the computer system 110 of FIG. 1, for example, upon executing the customization application 114. The process 400 is described in reference to FIG. 5, which shows an example diagram 500 for generating a custom mobile application using an image of a base application, according to some embodiments.

At block 402, customizations to the base application may be determined. For example, the base application may be customized for a given entity, such as a customer of a CRM system (e.g., organization, company, etc.). A user associated with the entity may operate a user system 502, as shown in FIG. 5. For example, the user system 502 may correspond to the user system 120 of FIG. 1. In this example, the user may request various customizations 504 to the base application through one or more interfaces, such as graphical user interfaces (GUIs), which may be provided by the computer system 110 to allow the user system 502 to interact with the customization application 114.

There may be any number of customizations 504 that may be made to the base application through the customization application 114. According to some embodiments, the customizations 504 may include user interface customizations, such as theme and color scheme modifications to match brand identity, font and text adjustments, custom layouts and screen overrides, custom data fields, personalized dashboards and homepages, among others. In some embodiments, the customizations 504 may include functional customizations, such as custom scripts for task automation, scheduled jobs and automated processes, customized workflows, and customized business processes, among others. According to some embodiments, the customizations 504 may include customized management of users of a CRM database associated with Customer A, such as customizable access levels and security policies. In some embodiments, the customizations 504 may include system integration customizations, such as custom uniform resource locators (URLs), custom application programming interfaces (APIs), and custom developer kits. Many variations are possible.

At block 404, the image of the base application may be obtained. According to various embodiments, the image 310 of the base application may be pulled from the registry 314.

At block 406, a container may be executed using the image 310 of the base application. According to some embodiments, Docker (developed by Docker, Inc., available at https://www.docker.com/) may be used to execute a container 506 using the image 310 of the base application. Upon execution, a Docker daemon may start the container 506 based on the image 310. For example, the container 506 may be executed in a paused or stopped state. The container 506 may provide an environment of the base application, including a corresponding file system, directory structure, and networking stack, for example. The environment may also provide access to data included with the image 310 of the base application, such as the source code of the base application, downloaded assets (e.g., drivers, development kits, plug-ins, libraries, APIs, etc.), and the build cache generated by Gradle.

At block 408, the customizations 504 determined at block 402 may be applied. As alluded to earlier, the repository of the base application may be cloned directly into the container 506. The repository may include the source code of the base application, downloaded assets, the build cache, among other data. According to various embodiments, the repository may be modified as needed to customize the base application based on the customizations 504. For example, to replace or add new graphic assets (e.g., images, icons, etc.), the corresponding assets may be copied into appropriate directories of the repository of the base application. In another example, to update configurations, such as embedding custom uniform resource locators (URLs) or custom application programming interfaces (APIs), appropriate configuration files in the repository of the base application may be modified.

At block 410, a mobile application 514 may be generated based on the customized base application. For example, according to various embodiments, the mobile application 514 may be generated from the image 310 of the base application in the container 506, including any customizations 504 that were applied to the image 310, as described above. A Gradle process may be executed to build the mobile application 514. According to some embodiments, the Gradle process may generate an Android© Package Kit (APK) file, which provides everything needed to run the customized base application on an Android device. According to some embodiments, the Gradle process may generate an iOS© App Store Package (IPA) file, which provides everything needed to run the customized base application on an iOS© device. Many variations are possible. The mobile application 514 may be distributed through the computing system 110 or an app store, for example.

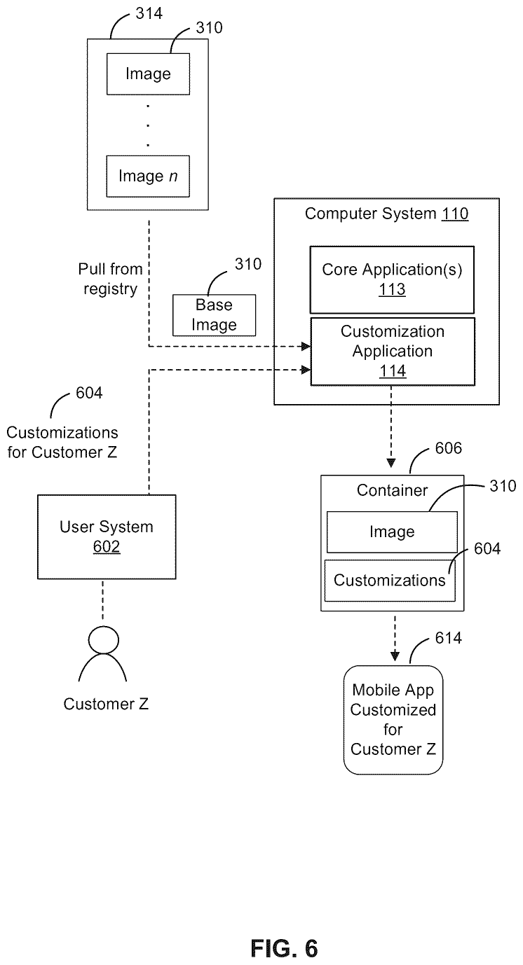

According to various embodiments, the same image 310 of the base application may be customized for other entities (e.g., users, customers, etc.). For example, FIG. 6 illustrates a similar approach for customizing the base application for another user (“Customer Z”) of the computing system 110. In this example, various customizations 604 are provided by a user system 602 being operated by the user. A container 606 using the image 310 of the base application may be executed, as described above. The customizations 604 may be applied, as described above. According to various embodiments, a mobile application 614 may be generated from the image 310 of the base application in the container 606, including any customizations 604 that were applied to the image 310, as described above.

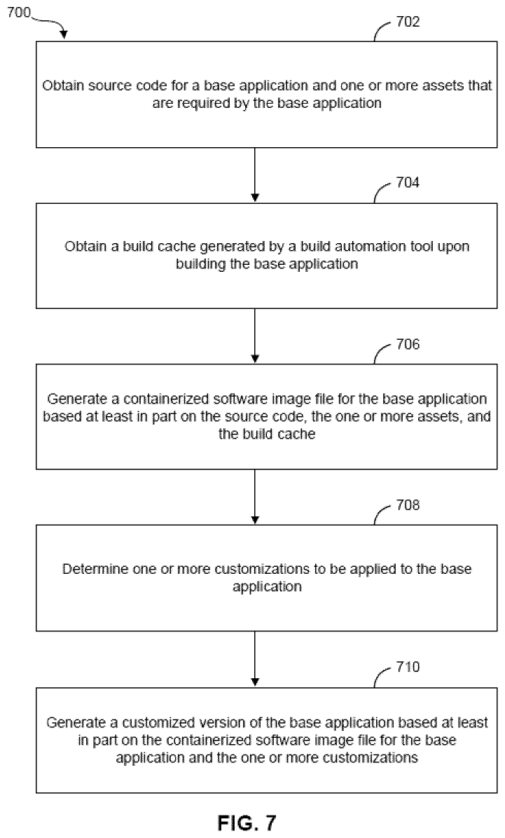

FIG. 7 shows a flow diagram of an example process 700, according to some embodiments. The process 700 can be performed by one or more processors of a computer system, such as the computer system 110 of FIG. 1.

At block 702, the computer system obtains source code for a base application and one or more assets that are required by the base application.

At block 704, the computer system obtains a build cache generated by a build automation tool upon building the base application.

At block 706, the computer system generates a containerized software image file for the base application based at least in part on the source code, the one or more assets, and the build cache.

At block 708, the computer system determines one or more customizations to be applied to the base application.

At block 710, the computer system generates a customized version of the base application based at least in part on the containerized software image file for the base application and the one or more customizations.

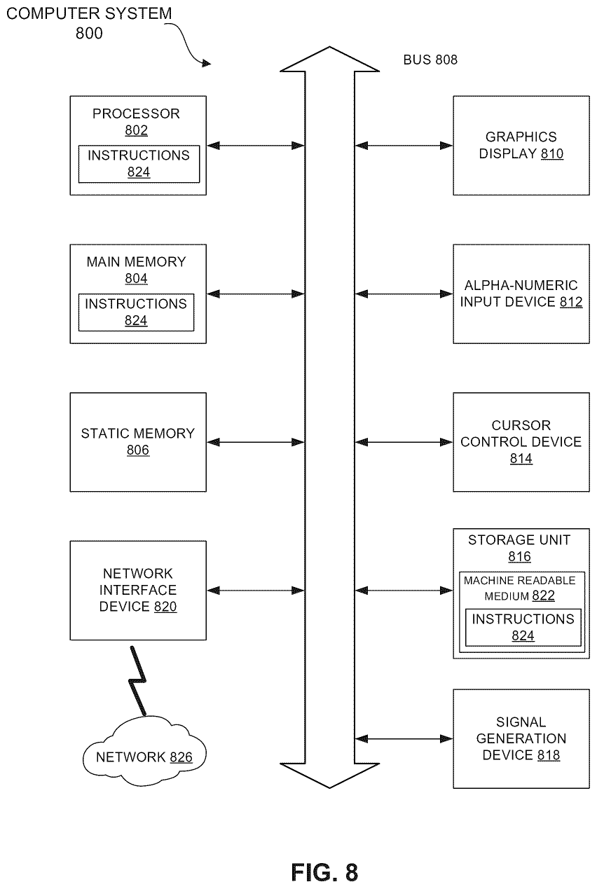

FIG. 8 is a block diagram illustrating a digital device in one example. The digital device may read instructions from a machine-readable medium and execute those instructions by a processor to perform the machine processing tasks discussed herein, such as the operations discussed above. Specifically, FIG. 8 shows a diagrammatic representation of a machine in the example form of a computer system 800 within which instructions 824 (e.g., software) for causing the machine to perform any one or more of the methodologies discussed herein may be executed. In alternative embodiments, the machine operates as a standalone device or may be connected (e.g., networked) to other machines, for instance, via the Internet. In a networked deployment, the machine may operate in the capacity of a server machine or a client machine in a server-client network environment, or as a peer machine in a peer-to-peer (or distributed) network environment.

The machine may be a server computer, a client computer, a personal computer (PC), a tablet PC, a set-top box (STB), a personal digital assistant (PDA), a cellular telephone, a smartphone, a web appliance, a network router, switch or bridge, or any machine capable of executing instructions 824 (sequential or otherwise) that specify actions to be taken by that machine. Further, while only a single machine is illustrated, the term “machine” shall also be taken to include any collection of machines that individually or jointly execute instructions 824 to perform any one or more of the methodologies discussed herein.

The example computer system 800 includes a processor 802 (e.g., a central processing unit (CPU), a graphics processing unit (GPU), a digital signal processor (DSP), one or more application-specific integrated circuits (ASICs), one or more radio-frequency integrated circuits (RFICs), or any combination of these), a main memory 804, and a static memory 806, which are configured to communicate with each other via a bus 808. The computer system 800 may further include a graphics display unit 810 (e.g., a plasma display panel (PDP), a liquid crystal display (LCD), a projector, or a cathode ray tube (CRT)). The computer system 800 may also include alphanumeric input device 812 (e.g., a keyboard), a cursor control device 814 (e.g., a mouse, a trackball, a joystick, a motion sensor, or other pointing instrument), a data store 816, a signal generation device 818 (e.g., a speaker), and a network interface device 820, which also is configured to communicate via the bus 808.

The data store 816 includes a machine-readable medium 822 on which is stored instructions 824 (e.g., software) embodying any one or more of the methodologies or functions described herein. The instructions 824 (e.g., software) may also reside, completely or at least partially, within the main memory 804 or within the processor 802 (e.g., within a processor's cache memory) during execution thereof by the computer system 800, the main memory 804 and the processor 802 also constituting machine-readable media. The instructions 824 (e.g., software) may be transmitted or received over a network 826 via network interface 820.

While machine-readable medium 822 is shown in an example embodiment to be a single medium, the term “machine-readable medium” should be taken to include a single medium or multiple media (e.g., a centralized or distributed database, or associated caches and servers) able to store instructions (e.g., instructions 824). The term “machine-readable medium” shall also be taken to include any medium that is capable of storing instructions (e.g., instructions 824) for execution by the machine and that cause the machine to perform any one or more of the methodologies disclosed herein. The term “machine-readable medium” includes, but should not be limited to, data repositories in the form of solid-state memories, optical media, and magnetic media.

In this description, the term “application” refers to computational logic for providing the specified functionality. An application can be implemented in hardware, firmware, and/or software. Where the applications described herein are implemented as software, the application can be implemented as a standalone program, but can also be implemented through other means, for example as part of a larger program, as any number of separate programs, or as one or more statically or dynamically linked libraries. It will be understood that the named applications described herein represent one embodiment, and other embodiments may include other applications. In addition, other embodiments may lack applications described herein and/or distribute the described functionality among the applications in a different manner. Additionally, the functionalities attributed to more than one application can be incorporated into a single application. In an embodiment where the applications as implemented by software, they are stored on a computer readable persistent storage device (e.g., hard disk), loaded into the memory, and executed by one or more processors as described above in connection with FIG. 8. Alternatively, hardware or software applications may be stored elsewhere within a computing system.

As referenced herein, a computer or computing system includes hardware elements used for the operations described here regardless of specific reference in FIG. 8 to such elements, including, for example, one or more processors, high-speed memory, hard disk storage and backup, network interfaces and protocols, input devices for data entry, and output devices for display, printing, or other presentations of data. Numerous variations from the system architecture specified herein are possible. The entities of such systems and their respective functionalities can be combined or redistributed

These and other aspects of the disclosure may be implemented by various types of hardware, software, firmware, etc. For example, some features of the disclosure may be implemented, at least in part, by machine-program product that include program instructions, state information, etc., for performing various operations described herein. Examples of program instructions include both machine code, such as produced by a compiler, and files containing higher-level code that may be executed by the computer using an interpreter. Examples of machine-program product include, but are not limited to, magnetic media such as hard disks, floppy disks, and magnetic tape; optical media such as CD-ROM disks; magneto-optical media; and hardware devices that are specially configured to store and perform program instructions, such as read-only memory devices (“ROM”) and random access memory (“RAM”).

Any of the above implementations may be used alone or together with one another in any combination. Although various implementations may have been motivated by various deficiencies with the prior art, which may be discussed or alluded to in one or more places in the specification, the implementations do not necessarily address any of these deficiencies. In other words, different implementations may address different deficiencies that may be discussed in the specification. Some implementations may only partially address some deficiencies or just one deficiency that may be discussed in the specification, and some implementations may not address any of these deficiencies.

While various implementations have been described herein, it should be understood that they have been presented by way of example only, and not limitation. Thus, the breadth and scope of the present application should not be limited by any of the implementations described herein but should be defined only in accordance with the following and later-submitted claims and their equivalents.

What is claimed is:

1. A computer-implemented method comprising:
obtaining, by a computing system, source code for a base application and one or more assets that are required by the base application;
obtaining, by the computing system, a build cache generated by a build automation tool upon building the base application;
generating, by the computing system, a containerized software image file for the base application based at least in part on the source code, the one or more assets, and the build cache;
determining, by the computing system, one or more customizations to be applied to the base application; and
generating, by the computing system, a customized version of the base application based at least in part on the containerized software image file for the base application and the one or more customizations.

2. The computer-implemented method of claim 1, further comprising:
triggering, by the computing system, the generation of the containerized software image for the base application based at least in part on a continuous integration (CI) and continuous delivery (CD) (or CI/CD) pipeline configured to automatically trigger builds of the base application upon detecting changes in a release branch.

3. The computer-implemented method of claim 1, wherein generating the containerized software image comprises:
launching, by the computing system, a buildpack process that converts a build of the base application to the containerized software image.

4. The computer-implemented method of claim 3, wherein the build of the base application is generated by the build automation tool.

5. The computer-implemented method of claim 1, wherein the one or more assets include one or more software libraries that are required by the base application.

6. The computer-implemented method of claim 1, wherein generating the customized version of the base application comprises:
applying the one or more customizations to an environment of the base application.

7. The computer-implemented method of claim 5, wherein the environment is provided in a Docker container executed using the containerized software image file for the base application.

8. The computer-implemented method of claim 1, wherein the one or more customizations to be applied to the base application include at least one of user interface customizations, brand identity matching, functional customizations, customized management of users of a CRM database, or custom system integration customizations.

9. The computer-implemented method of claim 1, further comprising:
generating, by the computing system, a mobile application for an entity based on the containerized software image file for the base application and the one or more customizations.

10. The computer-implemented method of claim 1, wherein the mobile application provides at least visual or functional customizations to the base application.

11. A computer system comprising:
one or more processors; and
memory storing instructions that, when executed, cause the one or more processors to perform:
obtaining source code for a base application and one or more assets that are required by the base application;
obtaining a build cache generated by a build automation tool upon building the base application;
generating a containerized software image file for the base application based at least in part on the source code, the one or more assets, and the build cache;
determining one or more customizations to be applied to the base application; and
generating a customized version of the base application based at least in part on the containerized software image file for the base application and the one or more customizations.

12. The computer system of claim 11, wherein the instructions further perform:
triggering the generation of the containerized software image for the base application based at least in part on a continuous integration (CI) and continuous delivery (CD) (or CI/CD) pipeline configured to automatically trigger builds of the base application upon detecting changes in a release branch.

13. The computer system of claim 11, wherein generating the containerized software image comprises:
launching a buildpack process that converts a build of the base application to the containerized software image.

14. The computer system of claim 13, wherein the build of the base application is generated by the build automation tool.

15. The computer system of claim 11, wherein the one or more assets include one or more software libraries that are required by the base application.

16. A non-transitory computer-readable medium storing program code, the program code including instructions that are executable by one or more processors of a computer system to perform:
obtaining source code for a base application and one or more assets that are required by the base application;
obtaining a build cache generated by a build automation tool upon building the base application;
generating a containerized software image file for the base application based at least in part on the source code, the one or more assets, and the build cache;
determining one or more customizations to be applied to the base application; and
generating a customized version of the base application based at least in part on the containerized software image file for the base application and the one or more customizations.

17. The non-transitory computer-readable medium of claim 16, wherein the instructions further perform:
triggering the generation of the containerized software image for the base application based at least in part on a continuous integration (CI) and continuous delivery (CD) (or CI/CD) pipeline configured to automatically trigger builds of the base application upon detecting changes in a release branch.

18. The non-transitory computer-readable medium of claim 16, wherein generating the containerized software image comprises:
launching a buildpack process that converts a build of the base application to the containerized software image.

19. The non-transitory computer-readable medium of claim 18, wherein the build of the base application is generated by the build automation tool.

20. The non-transitory computer-readable medium of claim 16, wherein the one or more assets include one or more software libraries that are required by the base application.
